(19) United States
(12) Patent Application Publication
(10) Pub. No.: US 2008/0127543 A1
(43) Pub. Date: Jun. 5, 2008

(54) Fly Fishing Line

(75) Inventor: Richard Charles William Wothers, Brecon (GB)

Correspondence Address: KING & SCHICKLI, PLLC, 247 NORTH BROADWAY, LEXINGTON, KY, 40507, US

(73) Assignee: FLY FISHING TECHNOLOGY LIMITED, Powys (GB)

(21) Appl. No.: 11/995,726

(22) PCT Filed: Jul. 12, 2006
(86) PCT No.: PCT/GB06/02586

§ 371 Date: Jan. 15, 2008

Related U.S. Application Data
(60) Provisional application No. 60/699,923, filed on Jul. 16, 2005.

(30) Foreign Application Priority Data
Jul. 16, 2005 (GB) 0514657.6

(51) Int. Cl. A01K 91/12

(52) U.S. Cl. 43/44.98

(57) ABSTRACT

A fly fishing line includes an elongate core member (12) having an external covering (14). The external covering includes a plurality of spaced longitudinal outwardly-extending projections (16) along at least part of its length. The projections (16) reduce the surface area of the line that is in contact with rings of a fly fishing rod, thereby reducing friction between the fly fishing line and the rod.

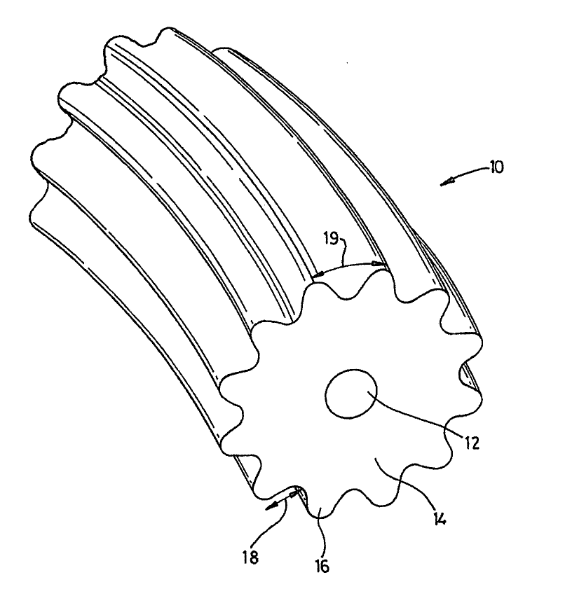

The present invention relates to fly fishing lines.

It is often desirable in angling for a fisherman to be able to cast the fly line as easily as possible. It can also be desirable for certain types of fishing lines have good buoyancy in the water.

The inventors have appreciated that one of the factors that can limit the ease and distance a fisherman is able to cast a line is friction between the line and the rings on the fishing rod as it is being cast.

According to a first aspect of the present invention there is provided a fly fishing line including an elongate core member having an external covering, the external covering including a plurality of spaced longitudinal outwardly-extending projections along at least part of its length. The projections normally reduce the surface area of the line that is in contact with the rings of the rod, thereby reducing the friction.

Typically, the external covering will cover substantially the entire length of the core member. The projections may extend along substantially the entire length of the external covering.

There may be between around six and forty projections on the line and in one embodiment the line has twelve said projections. The peaks/tips of the projections can be rounded or pointed. Gaps between adjacent pairs of the projections may be uniform or non-uniform. Central axes of the elongate core member and the external covering may substantially coincide.

The line may be formed so that its cross sectional area increases between one of its ends and a main body portion and then decreases (tapers) between the main body portion and its other end. Some sections of the line may be tapered. At least one section of the line may have a constant diameter.

The specific gravity (SG) of the fishing line may be less than one. The elongate core member may be formed of nylon or polyester, but it could be formed of other materials. The core may be of a braided, monofilament or twisted construction. The external covering may be formed of a plastics material such as polyurethane but could be formed of other materials such as polyvinylchloride (PVC). The external covering may be formed of a thermoplastic material or a thermosetting material.

The external covering may comprise a material that coats the core member. The external covering may be formed on the core member by means of an extrusion process. The cross sectional shape of the external covering may be determined by the shape of a die of an extruder. The external coating may be formed by process other than extrusion with the cross sectional shape formed by a die or by the addition or removal of material.

According to another aspect of the present invention there is provided a method of producing a fly fishing line including covering an elongate core member with an external covering, wherein the external covering has a plurality of spaced longitudinal outwardly-extending projections along at least part of its length.

The external covering may be formed on the elongate core member by means of an extrusion process.

Whilst the invention has been described above, it extends to any inventive combination of features set out above or in the following description.

The invention may be performed in various ways, and, by way of example only, embodiments thereof will now be described, reference being made through the accompanying FIGURE which shows a section through a portion of an example of the fishing line.

The portion of the fishing line 10 shown in the FIGURE includes an elongate core member 12, which may be of a braided, monofilament or twisted construction. The core member 12 is of a substantially circular cross section, although elongate members having other shapes could be used. The diameter of the core member is normally constant; however, it may vary along its length. If it varies then the diameter will normally increase from one end of the line (where the diameter can be around 0.7 mm) to a main body portion of the line where the diameter is substantially constant (typically greater than 1.0 mm and preferably greater than 2.0 mm, e.g. around 2.4 mm). The diameter may then decrease between the main body portion and the other end of the line. Such lines are generally known as tapering lines, although it will be understood that in other embodiments, other types of lines can be produced.

The core member 12 is substantially covered by an external covering 14. The diameter of the external covering 14 will normally increase from one end of the line to a main body portion of the line where the diameter is substantially constant. The diameter may then decrease between the main body portion and the other end of the line. Such lines are generally known as tapering lines, although it will be understood that in other embodiments, other types of lines can be produced.

The external covering 14 may be formed of a plastics material such as polyurethane or polyvinylchloride (PVC). The external covering 14 can be formed by the core member being coated with the plastics material as the core member is pulled through an extrusion or pulltrusion die. A suitable extrusion process can be carried out using the apparatus described in WO-A-8800521 and it will be understood that the various processes and materials described in that specification could be used in conjunction with the new type of fishing line described herein. Other methods of producing a desired cross-sectional shape include adding or removing sections of material from the external covering formed over the core. It should also be understood that when the terms “covered” or “covering” are used herein, they refer to the longitudinal/circumferential surface of the core member and do not necessarily mean that the ends/tips of the core member are covered by the external covering.

The shape of the die used in the extruder can determine the cross sectional shape of the external covering 14. In the example shown in the FIGURE the external covering 14 has twelve spaced longitudinal outwardly-extending projections extending along substantially its entire length. The projections 16 have rounded tips and are spaced apart at regular intervals. The trough to peak distance of one of the projections (shown by arrows 18) can be around 0.1 mm and the gap between the peaks of two adjacent projections (shown by arrows 19) can be about 0.3 mm.

It will be appreciated that variations to the cross sectional shape and dimensions can be made. For instance, different numbers of projections may be formed other than twelve, e.g., between six and forty projections. Further, the tips/peaks of the projections (and possibly the troughs between the projections) could be pointed instead of being rounded as shown in the FIGURE. Another possibility is that the shape/dimensions of the projections and/or the gaps between adjacent pairs of projections are non-uniform. The projections may not extend along the entire length of the line, that is, they could be intermittent (e.g. by closing off a part of the die of the extruder at various intervals). In yet another embodiment, the line could be rotated or oscillated as it is drawn through the extruder so that the projections twist or form wave-like shapes over the outer surface of the external covering 14 rather than closely following the main direction of the underlying core member 12.

It will be appreciated that the external covering 14 may directly coat the core member 12. Alternatively, one or more intermediate layers may be present between the core member and the external covering. The specific gravity (SG) of the resulting line can be less than 1 (e.g. 0.9), although it will be understood that in some embodiments the line could have an SG greater than 1 so that a sinking line can be produced.

The presence of the projections 16 means that the surface area of the line 10 that contacts the rings of a fishing rod is less than the contacting surface area of a conventional fishing line having a circular cross section. The resulting reduction in friction means that a fisherman can cast the line 10 with greater ease and further than a conventional line. For a fly line that is designed to float the flotation of line 10 is greater than that of a conventional round profiled line. As the line lies on the surface of the water, air can be trapped in the troughs created between the projections.

1. A fly fishing line including an elongate core member having an external covering, the external covering including a plurality of spaced longitudinal outwardly-extending projections along at least part of its length.

2. A fly fishing line according to claim 1, wherein the projections reduce the surface area of the line that is in contact with rings of a fly fishing rod, thereby reducing friction between the fly fishing line and the rod.

3. A fly fishing line according to claim 1, wherein the external covering covers substantially the entire length of the core member.

4. A fly fishing line according to anyone of claim 1, wherein the projections extend along substantially the entire length of the external covering.

5. A fly fishing line according to claim 1, wherein the number of projections is between 6 and 40.

6. A fly fishing line according to claim 5, wherein there are 12 said projections.

7. A fly fishing line according to claim 1, wherein peaks/tips of the projections are rounded or pointed.

8. A fly fishing line according to claim 1, wherein gaps between adjacent pairs of the projections are uniform.

9. A fly fishing line according to claim 1, wherein central axes of the elongate core member and the external covering substantially coincide.

10. A fly fishing line according to claim 1, wherein the line is formed so that its cross sectional area increases between one of its ends and a main body portion and then decreases (tapers) between the main body portion and its other end.

11. A fly fishing line according to claim 10, wherein the main body portion of the line has a constant diameter that is greater than 1.0 mm.

12. A fly fishing line according to claim 1, wherein the specific gravity (SG) of the fly fishing line is less than one.

13. A fly fishing tine according to claim 1, wherein the elongate core member is formed of nylon or polyester.

14. A fly fishing line according to claim 1, wherein the core member is of a braided, monofilament or twisted construction.

15. A fly fishing line according to claim 1, wherein the external covering is formed of a plastics material such as polyurethane or polyvinylchloride (PVC).

16. A fly fishing line according to anyone of claim 1, wherein the external covering is formed of a thermoplastic material or a thermosetting material.

17. A method of producing a fly fishing line, the method including:
covering an elongate core member with an external covering, wherein the external covering has a plurality of spaced longitudinal outwardly-extending projections along at least part of its length.

18. A method according to claim 17, wherein the external covering is formed on the elongate core member by means of an extrusion process.

19. A method according to claim 18, wherein a cross-sectional shape of a die used in the extrusion determines the shape of the projections.

20. A method according to claim 18, wherein the projections are formed by addition or removal of the external coating material.

21-22. (canceled)
